(19) United States
(12) Patent Application Publication
(10) Pub. No.: US 2015/0210175 A1
(43) Pub. Date: Jul. 30, 2015

(54) ELECTRIC VEHICLE, AND DEVICE AND METHOD FOR CHARGING SAME

(71) Applicants: Electronics and Telecommunications Research Institute, Daejeon (KR); LG CNS Co., Ltd., Seoul (KR)

(72) Inventors: You-Sung KANG, Daejeon (KR); Yong-Je CHOI, Daejeon (KR); Doo-Ho CHOI, Cheonan-Si (KR); Hyun-Sook CHO, Daejeon (KR); Eun-Kyung JUN, Seoul (KR); Doo-Il PARK, Seoul (KR); Byeong-Gyu HYEON, Seoul (KR); Joon-Ho SHIN, Incheon (KR); Dong-Young SHIN, Incheon (KR)

(73) Assignees: Electronics and Telecommunications Research Institute, Daejeon (KR); LG CNS Co., Ltd., Seoul (KR)

(21) Appl. No.: 14/601,638

(22) Filed: Jan. 21, 2015

(30) Foreign Application Priority Data
Jan. 27, 2014 (KR) 10-2014-0009872

(51) Int. Cl. B60L 11/18

(52) U.S. Cl. CPC B60L 11/1816

(57) ABSTRACT

An electric vehicle and a device and method for charging the electric vehicle are disclosed. The device for charging an electric vehicle includes a charger cable communication unit, a charger security unit, and a control unit. The charger cable communication unit receives encrypted electric vehicle charging information from an electric vehicle. The charger security unit decrypts the encrypted electric vehicle charging information. The control unit determines whether the decrypted electric vehicle charging information is identical with charger charging information. The charger security unit encrypts the charger charging information if the control unit of the device for charging an electric vehicle determines that the decrypted electric vehicle charging information is not identical with the charger charging information. The charger cable communication unit sends the encrypted charger charging information to the electric vehicle. The control unit charges the electric vehicle when an acknowledgement message is received from the electric vehicle.

### CROSS-REFERENCE TO RELATED APPLICATION

This application claims the benefit of Korean Patent Application No. 10-2014-0009872, filed Jan. 27, 2014, which is hereby incorporated by reference herein in its entirety.

### BACKGROUND

1. Technical Field

The present invention relates to an electric vehicle and a device and method for charging the same and, more particularly, to an electric vehicle and a device and method for charging the electric vehicle, in which security functionality is performed.

2. Description of the Related Art

Electric vehicles (EVs) were fabricated before gasoline and diesel vehicles, but have not been put to practical use due to their problems, such as their heavy battery weight and the excessive time it takes to charge an electric vehicle.

Due to a growing interest in electric vehicles using electric energy which results from the exhaustion of fossil fuel reserves and environmental pollution, active research into electric vehicles has been recently conducted.

An electric vehicle refers to a vehicle that is driven using an electric battery and an electric motor, that is, a vehicle using electricity as driving power, without using oil fuel and an engine for oil fuel. That is to say, an electric vehicle is driven by rotating a motor in such a way as to consume electricity accumulated in a battery, not fossil fuel energy.

Although the capacity of batteries has increased thanks to advanced technology, the batteries of electric vehicles should be charged like common vehicles using fossil fuel energy are supplied with oil at gas stations.

Accordingly, devices for charging an electric vehicle have been recently used to charge electric vehicles.

Meanwhile, when an electric vehicle is charged using a device for charging an electric vehicle, information is exchanged between the device for charging an electric vehicle and the electric vehicle. However, a problem arises in that there is no provision for separate security measures for the exchange of information between the electric vehicle and the device for charging an electric vehicle. In connection with this, Korean Patent Application Publication No. 2011-0090183 discloses a technology related to “System and Method for Charging the Battery of Electric Vehicle.”

### SUMMARY

At least one embodiment of the present invention is directed to the provision of an electric vehicle and a device and method for charging the electric vehicle, in which security functionality is performed.

In accordance with an aspect of the present invention, there is provided a method of charging an electric vehicle, including decrypting, by the charger security unit of a device for charging an electric vehicle, electric vehicle charging information received from the electric vehicle; determining, by the control unit of the device for charging an electric vehicle, whether the decrypted electric vehicle charging information is identical with charger charging information by comparing the decrypted electric vehicle charging information with the charger charging information; encrypting, by the charger security unit, the charger charging information if the control unit of the device for charging an electric vehicle determines that the decrypted electric vehicle charging information is not identical with the charger charging information; sending, by a charger cable communication unit of the device for charging an electric vehicle, the encrypted charger charging information to the electric vehicle; and receiving, by the device for charging an electric vehicle, an acknowledgement message from the electric vehicle, and charging, by the device for charging an electric vehicle, the electric vehicle.

The transmission and reception of the electric vehicle charging information or the charger charging information may be performed via a control pilot signal line included in a charging cable.

The electric vehicle charging information may be a unit charge price when the electric vehicle was previously charged, and the charger charging information may be a current unit charge price.

The method may further include decrypting, by the charger security unit of the device for charging an electric vehicle, received charging state information; and outputting, by the display unit of the device for charging an electric vehicle, the decrypted charging state information.

The charging state information may include a current charged level of the electric vehicle, a charge start time, an expected charge end time, an elapsed charge time, or a charging environment.

Determining, by the control unit of the device for charging an electric vehicle, whether the decrypted electric vehicle charging information is identical with the charger charging information may include charging, by the device for charging an electric vehicle, the electric vehicle based on the decrypted electric vehicle charging information if it is determined that the decrypted electric vehicle charging information is identical with the charger charging information.

In accordance with another aspect of the present invention, there is provided an electric vehicle, including an electric vehicle security unit configured to encrypt electric vehicle charging information; and an electric vehicle cable communication unit configured to send the encrypted electric vehicle charging information to a device for charging an electric vehicle; wherein the electric vehicle security unit decrypts the encrypted charger charging information when the electric vehicle cable communication unit receives encrypted charger charging information from the device for charging an electric vehicle; and wherein the electric vehicle cable communication unit sends an acknowledgement message to the device for charging an electric vehicle in response to the encrypted charger charging information.

The transmission and reception of the electric vehicle charging information or the charger charging information may be performed via a control pilot signal line included in a charging cable.

The acknowledgement message may be a reception acknowledgement message responsive to the charger charging information or an acknowledgement message responsive to an instruction to perform charging based on the charger charging information.

When charging is started by the device for charging an electric vehicle, the electric vehicle security unit may encrypt charging state information, and the electric vehicle cable communication unit may send the encrypted charging state information to the device for charging an electric vehicle.

The charging state information may include at least one of a current charged level of the electric vehicle, a charge start time, an expected charge end time, an elapsed charge time, and a charging environment.

In accordance with still another aspect of the present invention, there is provided a device for charging an electric vehicle, including a charger cable communication unit configured to receive encrypted electric vehicle charging information from an electric vehicle; a charger security unit configured to decrypt the encrypted electric vehicle charging information; and a control unit configured to determine whether the decrypted electric vehicle charging information is identical with charger charging information by comparing the decrypted electric vehicle charging information with the charger charging information; wherein the charger security unit encrypts the charger charging information if the control unit of the device for charging an electric vehicle determines that the decrypted electric vehicle charging information is not identical with the charger charging information; wherein the charger cable communication unit sends the encrypted charger charging information to the electric vehicle; and wherein the control unit charges the electric vehicle when an acknowledgement message is received from the electric vehicle in response to the encrypted charger charging information.

The transmission and reception of the electric vehicle charging information or the charger charging information may be performed via a control pilot signal line included in a charging cable.

The electric vehicle charging information may be a unit charge price when the electric vehicle was previously charged, and the charger charging information may be a current unit charge price.

The acknowledgement message may include an acknowledgement message responsive to the charger charging information or an acknowledgement message responsive to an instruction to perform charging based on the charger charging information.

The device may further include a display unit, and the display unit may be configured to output decrypted charging state information when the charger security unit decrypts the received charging state information.

The charging state information may include at least one of a current charged level of the electric vehicle, a charge start time, an expected charge end time, an elapsed charge time and a charging environment.

The control unit may compare the decrypted electric vehicle charging information with the charger charging information, and may charge the electric vehicle based on the decrypted electric vehicle charging information if it is determined that the decrypted electric vehicle charging information is identical with the charger charging information.

In accordance with still another aspect of the present invention, there is provided a method of charging an electric vehicle, including encrypting, by an electric vehicle security unit of an electric vehicle, electric vehicle charging information; sending, by an electric vehicle cable communication unit of the electric vehicle, the encrypted electric vehicle charging information to a device for charging an electric vehicle; receiving, by the electric vehicle cable communication unit of the electric vehicle, encrypted charger charging information from the device for charging an electric vehicle, and decrypting, by the electric vehicle cable communication unit of the electric vehicle, the encrypted charger charging information; sending, by the electric vehicle cable communication unit of the electric vehicle, an acknowledgement message to the device for charging an electric vehicle in response to the received charger charging information; and charging the electric vehicle.

The method may further include encrypting, by the electric vehicle security unit of the electric vehicle, charging state information when the electric vehicle is charged; and sending, by the electric vehicle cable communication unit of the electric vehicle, the encrypted charging state information to the device for charging an electric vehicle.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram schematically illustrating a state in which a device for charging an electric vehicle according to an embodiment of the present invention charges an electric vehicle;

FIG. 2 is a block diagram of an electric vehicle according to an embodiment of the present invention;

FIG. 3 is a block diagram of a device for charging an electric vehicle according to an embodiment of the present invention; and

FIGS. 4 and 5 are diagrams illustrating a method of charging an electric vehicle according to an embodiment of the present invention.

### DETAILED DESCRIPTION

Embodiments of the present invention are described in detail below with reference to the accompanying drawings so that those having ordinary knowledge in the technical field to which the present invention pertains can easily practice the present invention. The present invention may be implemented in various different ways, and is not limited to embodiments described herein. In order to clearly describe the present invention, descriptions unrelated to a description of the present invention are omitted, and like reference numbers are assigned to like components throughout the specification.

Throughout the specification and the claims, unless explicitly described to the contrary, the terms “include” and “comprise” and their variants, such as “includes,” “including,” “comprises,” and “comprising”, will be understood to imply the inclusion of stated components, not the exclusion of any other components.

Throughout the specification and the claims, when one component is described as being “connected” to another component, the one component may be “directly connected” to the other component or “electrically connected” to the other component via a third component.

In the following specification, an “electric vehicle (EV)” is based on a concept including all types of means of transportation or driving means that are driven using electric energy. This concept is not limited to a vehicle having a specific number of driving wheels or a specific shape. In other words, an electric vehicle described herein is not limited to a four-wheel vehicle, but is applied to all types of wheel vehicles, such as a two-wheel vehicle and a three-wheel vehicle. Furthermore, although a four-wheel electric vehicle is described as an example in order to help an understanding of the present invention and for convenience of description, the present invention is not limited to the example based on the concept of the electric vehicle described above. Moreover, the term “charging” generally refers to a process of supplying power to the battery of an electric vehicle so that the electric vehicle can be driven. Although charging may be classified into quick charging, slow charging, and contactless charging according to the time it takes to perform charging and the charging method, the term “charging” herein may be applied to all types of charging, including quick charging, slow charging, and contactless charging.

Furthermore, although the technical spirit of the present invention is described using a system for charging an electric vehicle as an embodiment, the technology is not limited to the system for charging an electric vehicle, but may be applied to related technical fields. Accordingly, it is apparent that the scope of the present invention can also be applied to charging systems in the same technical field or other similar technical fields to which a principle identical with or similar to the technical spirit of the present invention described in the claims and the specification can be applied.

An electric vehicle and a device and method for charging the electric vehicle according to embodiments of the present invention are described in detail below with reference to the accompanying drawings.

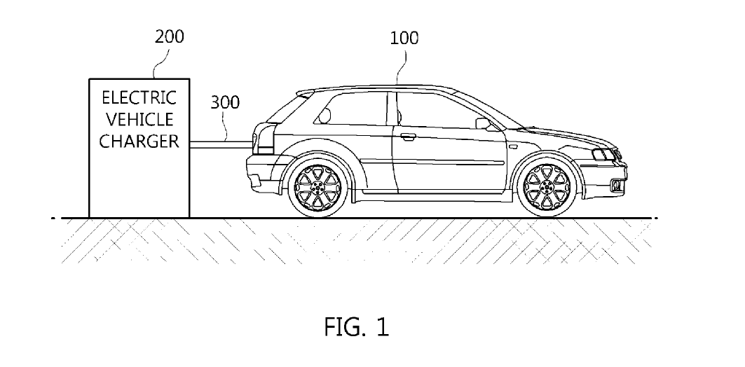

FIG. 1 is a diagram schematically illustrating a state in which a device for charging an electric vehicle (hereinafter referred to as an “electric vehicle charger”) according to an embodiment of the present invention charges an electric vehicle.

As illustrated in FIG. 1, when an electric vehicle 100 is charged, the electric vehicle 100 is connected to an electric vehicle charger 200 via a charging cable 300. Furthermore, the electric vehicle charger 200 supplies power to the electric vehicle 100 via the charging cable 300. The charging cable 300 according to an embodiment of the present invention may include a power line, via which power is supplied, and a control pilot signal line. According to an embodiment of the present invention, when the electric vehicle 100 is charged, the electric vehicle 100 and the electric vehicle charger 200 exchanges information via the control pilot signal line. According to an embodiment of the present invention, the electric vehicle charger 200 may send electric vehicle charging information or charging state information via the control pilot signal line, and may send charger charging information via the control pilot signal line.

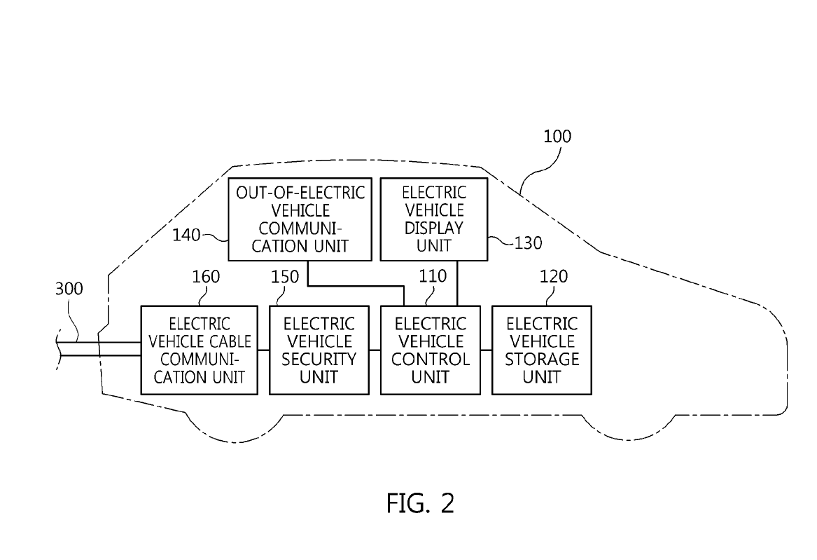

The electric vehicle according to an embodiment of the present invention is described below with reference to FIG. 2.

FIG. 2 is a block diagram of an electric vehicle according to an embodiment of the present invention.

An electric vehicle 100 according to an embodiment of the present invention includes an electric vehicle control unit 110, an electric vehicle storage unit 120, an electric vehicle display unit 130, an out-of-electric vehicle communication unit 140, an electric vehicle security unit 150, and an electric vehicle cable communication unit 160. The components of FIG. 2 are not indispensable, and thus an electric vehicle including a number of components larger or smaller than the number of the components of FIG. 2 may be implemented.

The components of the electric vehicle 100 are described below.

The electric vehicle control unit 110 controls the overall operation of the electric vehicle 100.

The electric vehicle storage unit 120 may store information about the electric vehicle 100. The electric vehicle storage unit 120 according to an embodiment of the present invention may store electric vehicle charging information. The electric vehicle charging information according to an embodiment of the present invention may include charging information about the previous charging of the electric vehicle 100. According to an embodiment of the present invention, when the electric vehicle 100 is charged, charging information may be stored in the electric vehicle storage unit 120. The charging information according to an embodiment of the present invention may include the charged level of the electric vehicle 100, a unit charge price per unit charged level, charging time, and/or a charging environment.

Furthermore, the electric vehicle storage unit 120 may include at least one type of storage media among flash memory-type, hard disk-type, multimedia card micro-type and card-type memory (e.g., SD or XD memory), random access memory (RAM), static random access memory (SRAM), read-only memory (ROM), electrically erasable programmable read-only memory (EEPROM), programmable read-only memory (PROM), magnetic memory, a magnetic disk, and an optical disk. The electric vehicle 100 according to an embodiment of the present invention may also operate in conjunction with web storage that performs the storage function of the electric vehicle storage unit 120 over the Internet.

The electric vehicle display unit 130 outputs electric vehicle charging information or charging state information according to an embodiment of the present invention. The charging state information according to an embodiment of the present invention may be the current charging state of the electric vehicle 100. The charging state information according to an embodiment of the present invention may include the current charged level of the electric vehicle 100, a charge start time, an expected charge end time, an elapsed charge time, or a charging environment.

The out-of-electric vehicle communication unit 140 performs communication with another vehicle or a digital device outside the electric vehicle 100.

The electric vehicle security unit 150 decrypts information received by the electric vehicle 100, or encrypts information to be transmitted to the outside of the electric vehicle 100. The electric vehicle security unit 150 according to an embodiment of the present invention encrypts charging information to be transmitted to the electric vehicle charger 200. Furthermore, the electric vehicle security unit 150 according to an embodiment of the present invention encrypts charging information received from the electric vehicle charger 200.

The electric vehicle cable communication unit 160 communicates with the electric vehicle charger 200. The electric vehicle cable communication unit 160 according to an embodiment of the present invention exchanges charging information with the electric vehicle charger 200.

The electric vehicle security unit 150 and the electric vehicle control unit 110 can be implemented by at least one of processors executing programs stored in the electric vehicle storage unit 120.

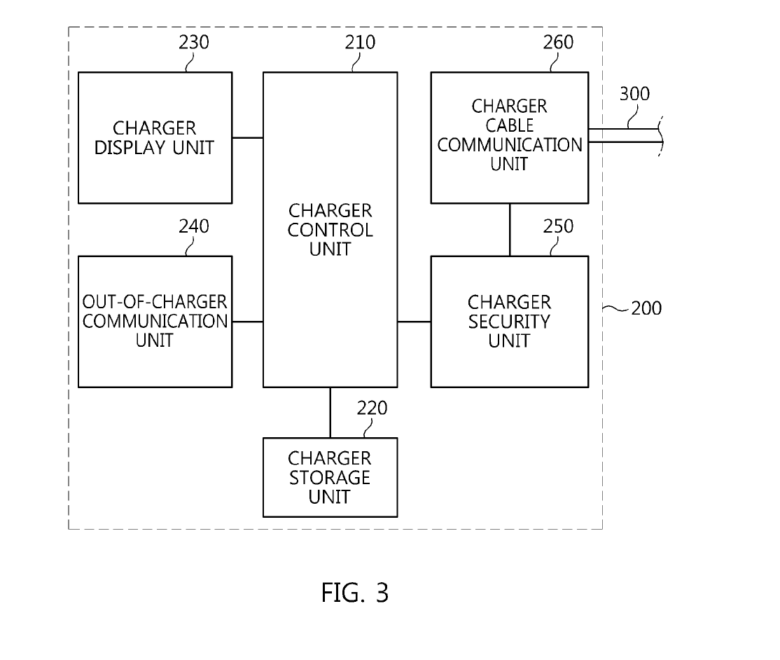

An electric vehicle charger according to an embodiment of the present invention is described below with reference to FIG. 3.

FIG. 3 is a block diagram of the electric vehicle charger according to an embodiment of the present invention.

The electric vehicle charger 200 according to an embodiment of the present invention includes a charger control unit 210, a charger storage unit 220, a charger display unit 230, an out-of-charger communication unit 240, a charger security unit 250, and a charger cable communication unit 260. The components of FIG. 3 are not indispensable, and the electric vehicle charger 200 including a number of components larger or smaller than the number of components of FIG. 3 may be implemented.

The components of the electric vehicle charger 200 are described below.

The charger control unit 210 controls the overall operation of the electric vehicle charger 200.

The charger storage unit 220 may store information about the electric vehicle charger 200. The charger storage unit 220 according to an embodiment of the present invention may store charger charging information. The charger charging information according to an embodiment of the present invention may include charging information about current charging. According to an embodiment of the present invention, the charger storage unit 220 may store charging information that is updated daily. The charger charging information according to an embodiment of the present invention may include charging information on that day. The charging information according to an embodiment of the present invention may include the charged level of the electric vehicle 100, a unit charge price per unit charged level, a charging time, or a charging environment.

Furthermore, the charger storage unit 220 may include at least one type of storage media among flash memory-type, hard disk-type, multimedia card micro-type and card-type memory (e.g., SD or XD memory), RAM, SRAM, ROM, EEPROM, PROM, magnetic memory, a magnetic disk, and an optical disk. The electric vehicle charger 200 according to an embodiment of the present invention may also operate in conjunction with web storage that performs the storage function of the charger storage unit 220 over the Internet.

The charger display unit 230 outputs charger charging information or charging state information according to an embodiment of the present invention. The charging state information according to an embodiment of the present invention may include the current charging state of the electric vehicle 100. The charging state information according to an embodiment of the present invention may include the current charged level of the electric vehicle 100, a charge start time, an expected charge end time, an elapsed charge time, or a charging environment.

The out-of-charger communication unit 240 performs communication with another vehicle, the electric vehicle 100, another electric vehicle charger, or a digital device outside the electric vehicle charger 200.

The charger security unit 250 decrypts information received by the electric vehicle charger 200, or encrypts information to be transmitted to the outside of the electric vehicle charger 200. The charger security unit 250 according to an embodiment of the present invention decrypts charging information received by the electric vehicle charger 200. Furthermore, the charger security unit 250 according to an embodiment of the present invention encrypts charging information to be transmitted to the electric vehicle 100.

The charger cable communication unit 260 performs communication with the electric vehicle 100. The charger cable communication unit 260 according to an embodiment of the present invention exchanges charging information with the electric vehicle 100.

The charger control unit 210 and the charger security unit 250 can be implemented by at least one of processors executing programs stored in the charger storage unit 220.

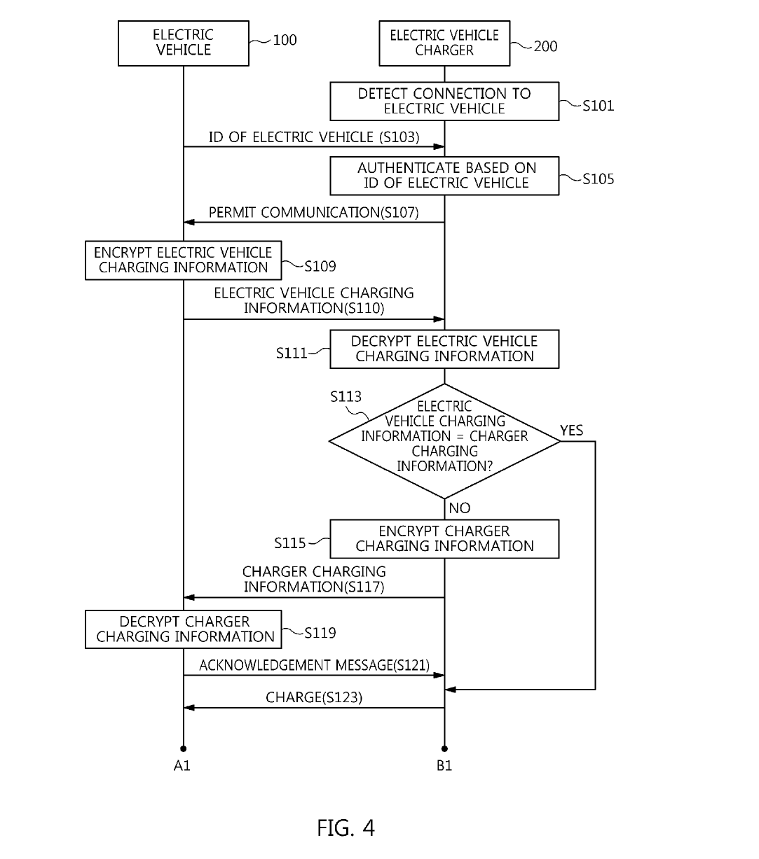

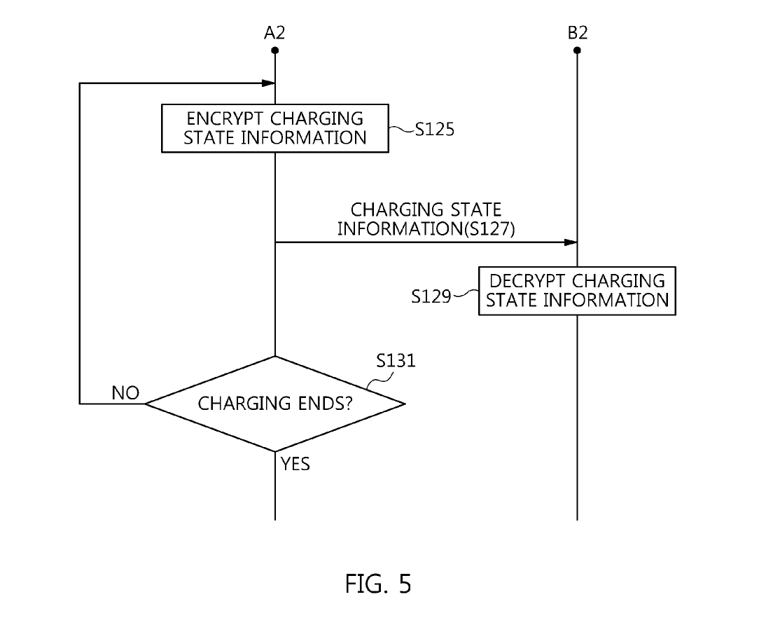

A method of charging an electric vehicle according to an embodiment of the present invention is described below with reference to FIGS. 4 and 5.

FIGS. 4 and 5 are diagrams illustrating the method of charging the electric vehicle according to an embodiment of the present invention.

In FIGS. 4 and 5, A1 is connected to A2, and B1 is connected to B2.

The charger control unit 210 detects a connection between the electric vehicle 100 and the electric vehicle charger 200 at step S101. According to an embodiment of the present invention, the electric vehicle 100 and the electric vehicle charger 200 may be connected via the charging cable 300. In the following process, sending and receiving charging information are performed via the charging cable 300. Furthermore, according to an embodiment of the present invention, the cable communication units 160 and 260 of the electric vehicle and the electric vehicle charger may send and receive ID information, an acknowledgement message, a communication permission message, and charging state information via the charging cable 300. Furthermore, the charging cable 300 may include a control pilot signal line. According to an embodiment of the present invention, the electric vehicle 100 and the electric vehicle charger 200 may send and receive the charging information ID, acknowledgement message, communication permission message and charging state information of the electric vehicle or the electric vehicle charger via the control pilot signal line.

The electric vehicle cable communication unit 160 sends information about the ID of the electric vehicle 100 to the electric vehicle charger 200 at step S103. In this case, the ID information may be received by the charger cable communication unit 260.

The charger control unit 210 authenticates the electric vehicle 100 based on the ID information of the electric vehicle 100 at step S105.

The charger cable communication unit 260 sends a communication permission message to the electric vehicle 100 at step S107. In this case, the communication permission message may be received by the electric vehicle cable communication unit 160.

When the electric vehicle 100 receives the communication permission message, the electric vehicle security unit 150 encrypts the electric vehicle charging information at step S109.

The electric vehicle cable communication unit 160 sends the encrypted electric vehicle charging information to the electric vehicle charger 200 at step S110. In this case, the electric vehicle charging information may be received by the charger cable communication unit 260.

The charger security unit 250 decrypts the received electric vehicle charging information at step S111.

The charger control unit 210 determines whether the decrypted electric vehicle charging information is identical with charger charging information at step S113. If, as a result of the determination, it is determined that the decrypted electric vehicle charging information is identical with the charger charging information, the charger control unit 210 charges the electric vehicle 100 at step S123. According to an embodiment of the present invention, the electric vehicle charging information may be a unit charge price when the electric vehicle 100 was previously charged, and the charger charging information may be a current unit charge price.

If, as a result of the determination, it is determined that the decrypted electric vehicle charging information is not identical with the charger charging information, the charger security unit 250 encrypts the charger charging information at step S115. According to an embodiment of the present invention, if electric vehicle charging information is not identical with charger charging information, it may correspond to a case where only the electric vehicle charger 200 has received new data and the charger charging information has been updated. Furthermore, according to an embodiment of the present invention, if electric vehicle charging information is not identical with charger charging information, it may correspond to a case where false charging electric vehicle charging information has been stored in the electric vehicle 100. The charger cable communication unit 260 sends the encrypted charger charging information to the electric vehicle 100 at step S117. In this case, the charger charging information may be received by the electric vehicle cable communication unit 160.

The electric vehicle security unit 150 decrypts the received charger charging information at step S119.

The electric vehicle cable communication unit 160 sends an acknowledgement message to the electric vehicle charger 200 based on the received charger charging information at step S121. In this case, the acknowledgement message may be received by the charger cable communication unit 260. The acknowledgement message according to an embodiment of the present invention may be a reception acknowledgement message responsive to charger charging information or an acknowledgement message responsive to an instruction to perform charging based on charger charging information.

When the acknowledgement message is received, the charger control unit 210 charges the electric vehicle 100 by supplying power to the electric vehicle 100 at step S123.

When the power is supplied to the electric vehicle 100, the electric vehicle security unit 150 encrypts charging state information at step S125. In this case, the electric vehicle display unit 130 may output the charging state information.

The electric vehicle cable communication unit 160 sends the encrypted charging state information to the electric vehicle charger 200 at step S127. In this case, the charging state information may be received by the charger cable communication unit 260.

The charger security unit 250 decrypts the received charging state information at step S129. In this case, the charger display unit 230 may output the charging state information.

The electric vehicle control unit 110 determines whether the charging has been terminated at step S131. If, as a result of the determination, it is determined that the charging has not been terminated, the electric vehicle control unit 110 encrypts the charging state information again.

As described above, the present invention provides security functionality upon exchanging information between the electric vehicle and the electric vehicle charger using the electric vehicle and the electric vehicle charger each including the security unit.

Although the specific embodiments of the present invention have been disclosed for illustrative purposes, those skilled in the art will appreciate that various modifications, additions and substitutions are possible without departing from the scope and spirit of the invention as disclosed in the accompanying claims.

What is claimed is:

1. A device for charging an electric vehicle, comprising:
a charger cable communication unit configured to receive encrypted electric vehicle charging information from an electric vehicle;
a charger security unit configured to decrypt the encrypted electric vehicle charging information; and
a control unit configured to determine whether the decrypted electric vehicle charging information is identical with charger charging information by comparing the decrypted electric vehicle charging information with the charger charging information;
wherein the charger security unit encrypts the charger charging information if the control unit of the device for charging an electric vehicle determines that the decrypted electric vehicle charging information is not identical with the charger charging information;
wherein the charger cable communication unit sends the encrypted charger charging information to the electric vehicle; and
wherein the control unit charges the electric vehicle when an acknowledgement message is received from the electric vehicle in response to the encrypted charger charging information.

2. The device of claim 1, wherein the transmission and reception of the electric vehicle charging information or the charger charging information are performed via a control pilot signal line included in a charging cable.

3. The device of claim 1, wherein the electric vehicle charging information is a unit charge price when the electric vehicle was previously charged, and the charger charging information is a current unit charge price.

4. The device of claim 1, wherein the acknowledgement message comprises an acknowledgement message responsive to the charger charging information or an acknowledgement message responsive to an instruction to perform charging based on the charger charging information.

5. The device of claim 1, further comprising a display unit, wherein the display unit is configured to output decrypted charging state information when the charger security unit decrypts the received charging state information.

6. The device of claim 5, wherein the charging state information comprises at least one of a current charged level of the electric vehicle, a charge start time, an expected charge end time, an elapsed charge time and a charging environment.

7. The device of claim 6, wherein the control unit compares the decrypted electric vehicle charging information with the charger charging information, and charges the electric vehicle based on the decrypted electric vehicle charging information if it is determined that the decrypted electric vehicle charging information is identical with the charger charging information.

8. A method of charging an electric vehicle, comprising:
decrypting, by a charger security unit of a device for charging an electric vehicle, electric vehicle charging information received from the electric vehicle;
determining, by a control unit of the device for charging an electric vehicle, whether the decrypted electric vehicle charging information is identical with charger charging information by comparing the decrypted electric vehicle charging information with the charger charging information;
encrypting, by the charger security unit, the charger charging information if the control unit of the device for charging an electric vehicle determines that the decrypted electric vehicle charging information is not identical with the charger charging information;
sending, by a charger cable communication unit of the device for charging an electric vehicle, the encrypted charger charging information to the electric vehicle; and
receiving, by the device for charging an electric vehicle, an acknowledgement message from the electric vehicle, and charging, by the device for charging an electric vehicle, the electric vehicle.

9. The method of claim 8, wherein the transmission and reception of the electric vehicle charging information or the charger charging information are performed via a control pilot signal line included in a charging cable.

10. The method of claim 8, wherein the electric vehicle charging information is a unit charge price when the electric vehicle was previously charged, and the charger charging information is a current unit charge price.

11. The method of claim 8, further comprising:
decrypting, by the charger security unit of the device for charging an electric vehicle, received charging state information; and
outputting, by a display unit of the device for charging an electric vehicle, the decrypted charging state information.

12. The method of claim 11, wherein the charging state information comprises a current charged level of the electric vehicle, a charge start time, an expected charge end time, an elapsed charge time, or a charging environment.

13. The method of claim 12, wherein determining, by the control unit of the device for charging an electric vehicle, whether the decrypted electric vehicle charging information is identical with the charger charging information comprises charging, by the device for charging an electric vehicle, the electric vehicle based on the decrypted electric vehicle charging information if it is determined that the decrypted electric vehicle charging information is identical with the charger charging information.

14. An electric vehicle, comprising:
an electric vehicle security unit configured to encrypt electric vehicle charging information; and
an electric vehicle cable communication unit configured to send the encrypted electric vehicle charging information to a device for charging an electric vehicle;
wherein the electric vehicle security unit decrypts the encrypted charger charging information when the electric vehicle cable communication unit receives encrypted charger charging information from the device for charging an electric vehicle; and
wherein the electric vehicle cable communication unit sends an acknowledgement message to the device for charging an electric vehicle in response to the encrypted charger charging information.

15. The electric vehicle of claim 14, wherein the transmission and reception of the electric vehicle charging information or the charger charging information are performed via a control pilot signal line included in a charging cable.

16. The electric vehicle of claim 14, wherein the acknowledgement message is a reception acknowledgement message responsive to the charger charging information or an acknowledgement message responsive to an instruction to perform charging based on the charger charging information.

17. The electric vehicle of claim 16, wherein, when charging is started by the device for charging an electric vehicle, the electric vehicle security unit encrypts charging state information, and the electric vehicle cable communication unit sends the encrypted charging state information to the device for charging an electric vehicle.

18. The electric vehicle of claim 17, wherein the charging state information comprises at least one of a current charged level of the electric vehicle, a charge start time, an expected charge end time, an elapsed charge time, and a charging environment.

19. A method of charging an electric vehicle, comprising:
encrypting, by an electric vehicle security unit of an electric vehicle, electric vehicle charging information;
sending, by an electric vehicle cable communication unit of the electric vehicle, the encrypted electric vehicle charging information to a device for charging an electric vehicle;
receiving, by the electric vehicle cable communication unit of the electric vehicle, encrypted charger charging information from the device for charging an electric vehicle, and decrypting, by the electric vehicle cable communication unit of the electric vehicle, the encrypted charger charging information;
sending, by the electric vehicle cable communication unit of the electric vehicle, an acknowledgement message to the device for charging an electric vehicle in response to the received charger charging information; and
charging the electric vehicle.

20. The method of claim 19, further comprising:
encrypting, by the electric vehicle security unit of the electric vehicle, charging state information when the electric vehicle is charged; and
sending, by the electric vehicle cable communication unit of the electric vehicle, the encrypted charging state information to the device for charging an electric vehicle.
